(19) United States
(12) Patent Application Publication
(10) Pub. No.: US 2017/0351651 A1
(43) Pub. Date: Dec. 7, 2017

(54) SMART BOOKMARK DEVICE AND BOOKMARK SYNCHRONIZATION SYSTEM

(71) Applicant: Intel Corporation, Santa Clara, CA (US)

(72) Inventors: Handeep Kaur, Mather, CA (US); Yuri I. Krimon, Folsom, CA (US); Georgianna A. Bernal, Folsom, CA (US)

(21) Appl. No.: 15/170,101

(22) Filed: Jun. 1, 2016

(51) Int. Cl. G06F 17/24; G06F 3/16; G06F 3/0483; G06F 3/03; G06F 3/14; H04L 29/06; G06K 9/00

(52) U.S. Cl. CPC G06F 17/241; H04L 67/42; G06F 3/16; G06K 9/00442; G06F 3/0304; G06F 3/14; G06F 3/0483; G06K 2209/01

(57) ABSTRACT

Technologies for smart bookmark synchronization may include a smart bookmark device, a bookmark server, and one or more client computing devices. The smart bookmark device transmits an identification of a book to the bookmark server, which determines a format of the book based on the identification. The smart bookmark device captures sensor data indicative of the current reading position of a user in the book and transmits the sensor data to the bookmark server. The sensor data may include image data of a current page in the book. The bookmark server determines bookmark data indicative of the current reading position based on the sensor data. The bookmark server transmits the bookmark data to the smart bookmark device and, in some embodiments, to the client computing devices and/or applications. The client computing devices may synchronize playback of a digital media book with the bookmark data. Other embodiments are described and claimed.

### BACKGROUND

Digital media consumption is an important application for many current computing devices. For example, many people read electronic books (e-books) using computing devices such as smartphones, tablets, and e-readers. As another example, many people listen to audiobooks using similar computing devices. Of course, while digital books are increasing in popularity, traditional paper books remain popular. Accordingly, the same work may be available in multiple formats, including digital and non-digital formats. The user experience reading a paper book remains disconnected from interactions with digital media.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for smart bookmark data synchronization;

FIG. 2 is a schematic diagram of a smart bookmark device and a physical book of the system of FIG. 1;

FIG. 3 is a simplified block diagram of at least one embodiment of various environments that may be established by the system of FIGS. 1 and 2;

FIG. 4 is a simplified flow diagram of at least one embodiment of a method for bookmark data synchronization that may be executed by a smart bookmark device of FIGS. 1-3; and

FIG. 5 is a simplified flow diagram of at least one embodiment of a method for bookmark data synchronization that may be executed by a bookmark server of the system of FIGS. 1-3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

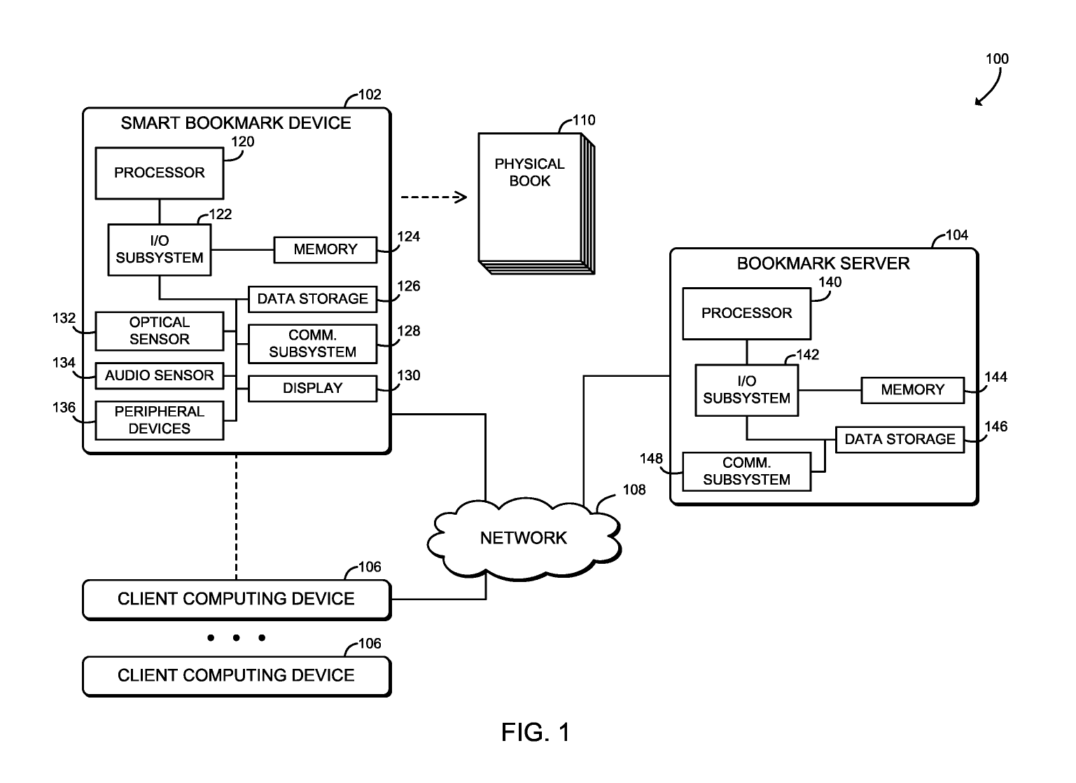

Referring now to FIG. 1, in an illustrative embodiment, a system 100 for smart bookmark synchronization includes a smart bookmark device 102, a bookmark server 104, and may include one or more client computing devices 106. In use, a user of the smart bookmark device 102 reads a physical book 110. The smart bookmark device 102 captures sensor data that indicates the user's current reading position in the book 110, such as images of the current page. The smart bookmark device 102 transmits the sensor data to the bookmark server 104, which analyzes the sensor data to generate bookmark data, which indicates the user's current reading position. The bookmark server 104 synchronizes the bookmark data with the smart bookmark device 102 and other devices such as one or more client computing devices 106. By generating and synchronizing bookmark data, the system 100 may allow the user to easily switch between different formats of a book 110, including electronic media versions of the book 110 such as e-books, audiobooks, or video media (such as a movie version of a book or lecture). In some embodiments, the system 100 may allow the smart bookmark device 102 to provide advanced accessibility features to a user while reading a physical book 110. Additionally or alternatively, in some embodiments, the bookmark server 104 may also receive annotation data from the client computing devices 106 and synchronize the annotation data with the smart bookmark device 102. Thus, the system 100 may allow annotation data to be synchronized between devices and between book formats, including between a physical book 110 and various types of electronic media books.

The smart bookmark device 102 may be embodied as any type of computation or computer device capable of performing the functions described herein, including, without limitation, a consumer electronic device, a connected device, an embedded device, a mobile computing device, a smart phone, a wearable computing device, a laptop computer, a notebook computer, a tablet computer, a network appliance, a computer, a multiprocessor system, a distributed computing system, and/or a processor-based system. As shown in FIG. 1, the smart bookmark device 102 illustratively includes a processor 120, an input/output subsystem 122, a memory 124, a data storage device 126, and a communication subsystem 128. Of course, the smart bookmark device 102 may include other or additional components, such as those commonly found in a consumer electronic device (e.g., various input/output devices), in other embodiments. Additionally, in some embodiments, one or more of the illustrative components may be incorporated in, or otherwise form a portion of, another component. For example, the memory 124, or portions thereof, may be incorporated in the processor 120 in some embodiments.

The processor 120 may be embodied as any type of processor capable of performing the functions described herein. The processor 120 may be embodied as a single or multi-core processor(s), digital signal processor, microcontroller, or other processor or processing/controlling circuit. Similarly, the memory 124 may be embodied as any type of volatile or non-volatile memory or data storage capable of performing the functions described herein. In operation, the memory 124 may store various data and software used during operation of the smart bookmark device 102 such as operating systems, applications, programs, libraries, and drivers. The memory 124 is communicatively coupled to the processor 120 via the I/O subsystem 122, which may be embodied as circuitry and/or components to facilitate input/output operations with the processor 120, the memory 124, and other components of the smart bookmark device 102. For example, the I/O subsystem 122 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 122 may form a portion of a system-on-a-chip (SoC) and be incorporated, along with the processors 120, the memory 124, and other components of the smart bookmark device 102, on a single integrated circuit chip.

The data storage device 126 may be embodied as any type of device or devices configured for short-term or long-term storage of data such as, for example, memory devices and circuits, memory cards, hard disk drives, solid-state drives, or other data storage devices. The communication subsystem 128 of the smart bookmark device 102 may be embodied as any communication circuit, device, or collection thereof, capable of enabling communications between the smart bookmark device 102, the bookmark server 104, the client computing devices 106, and/or other remote devices over the network 108. The communication subsystem 128 may be configured to use any one or more communication technology (e.g., wired or wireless communications) and associated protocols (e.g., Ethernet, Bluetooth®, Wi-Fi®, WiMAX, etc.) to effect such communication.

As shown, the smart bookmark device 102 may also include a display 130, an optical sensor 132, an audio sensor 134, and one or more peripheral devices 136. The display 130 may be embodied as any type of display capable of displaying digital information such as an electronic ink (e-ink) display, a liquid crystal display (LCD), a light emitting diode (LED), a plasma display, or other type of display device.

The optical sensor 132 may be embodied as a light sensor, digital camera, or other digital imaging device integrated with the smart bookmark device 102 or otherwise communicatively coupled thereto. The optical sensor 132 may include an electronic image sensor, such as an active-pixel sensor (APS), e.g., a complementary metal-oxide-semiconductor (CMOS) sensor, or a charge-coupled device (CCD). The optical sensor 132 may be used to capture images or other optical data of the environment of the smart bookmark device 102, such as images of a paper book 110 being read by a user of the smart bookmark device 102. Similarly, the audio sensor 134 may be embodied as any sensor capable of capturing audio signals such as one or more microphones, a line input jack and associated circuitry, an analog-to-digital converter (ADC), or other type of audio sensor. In some embodiments, the audio sensor 134 may be embodied as a remote device, such as a remote microphone paired with Bluetooth. The audio sensor 134 may be used to detect the audio environment of the smart bookmark device 102, such as spoken utterances by the user of the smart bookmark device 102.

As shown, the smart bookmark device 102 may also include one or more peripheral devices 136. The peripheral devices 136 may include any number of additional input/output devices, interface devices, and/or other peripheral devices. For example, in some embodiments, the peripheral devices 136 may include one or more input buttons, touch screen, graphics circuitry, keyboard, mouse, speaker system, network interface, and/or other input/output devices.

The bookmark server 104 may be embodied as any type of computation or computer device capable of performing the functions described herein, including, without limitation, a computer, a multiprocessor system, a server, a rack-mounted server, a blade server, a network appliance, a distributed computing system, a processor-based system, and/or a consumer electronic device. As such, the bookmark server 104 may be embodied as a single server computing device or a collection of servers and associated devices. For example, in some embodiments, the bookmark server 104 may be embodied as a “virtual server” formed from multiple computing devices distributed across the network 108 and operating in a public or private cloud. Accordingly, although the bookmark server 104 is illustrated in FIG. 1 and described below as embodied as a single server computing device, it should be appreciated that the bookmark server 104 may be embodied as multiple devices cooperating together to facilitate the functionality described below. Illustratively, the bookmark server 104 includes a processor 140, an I/O subsystem 142, a memory 144, a data storage device 146, a communication subsystem 148, and/or other components and devices commonly found in a server or similar computing device. Those individual components of the bookmark server 104 may be similar to the corresponding components of the smart bookmark device 102, the description of which is applicable to the corresponding components of the bookmark server 104 and is not repeated herein so as not to obscure the present disclosure.

Similarly, each client computing device 106 may be embodied as any type of computation or computer device capable of performing the functions described herein, including, without limitation, a mobile computing device, a smart phone, an e-reader device, a computer, a laptop computer, a notebook computer, a tablet computer, a wearable computing device, a network appliance, an in-vehicle infotainment device, a web appliance, a distributed computing system, a processor-based system, and/or a consumer electronic device. The client computing device 106 may include components and devices commonly found in a smartphone or similar computing device, such as a processor, an I/O subsystem, a memory, a data storage device, a communication subsystem, and/or other peripheral devices. Those individual components of the client computing device 106 may be similar to the corresponding components of the smart bookmark device 102 and/or the bookmark server 104, the description of which is applicable to the corresponding components of the client computing device 106 and is not repeated herein so as not to obscure the present disclosure.

As discussed in more detail below, the smart bookmark device 102, the bookmark server 104, and the client computing devices 106 may be configured to transmit and receive data with each other and/or other devices of the system 100 over the network 108. The network 108 may be embodied as any number of various wired and/or wireless networks. For example, the network 108 may be embodied as, or otherwise include, a wired or wireless local area network (LAN), a wired or wireless wide area network (WAN), a cellular network, and/or a publicly-accessible, global network such as the Internet. As such, the network 108 may include any number of additional devices, such as additional computers, routers, and switches, to facilitate communications among the devices of the system 100.

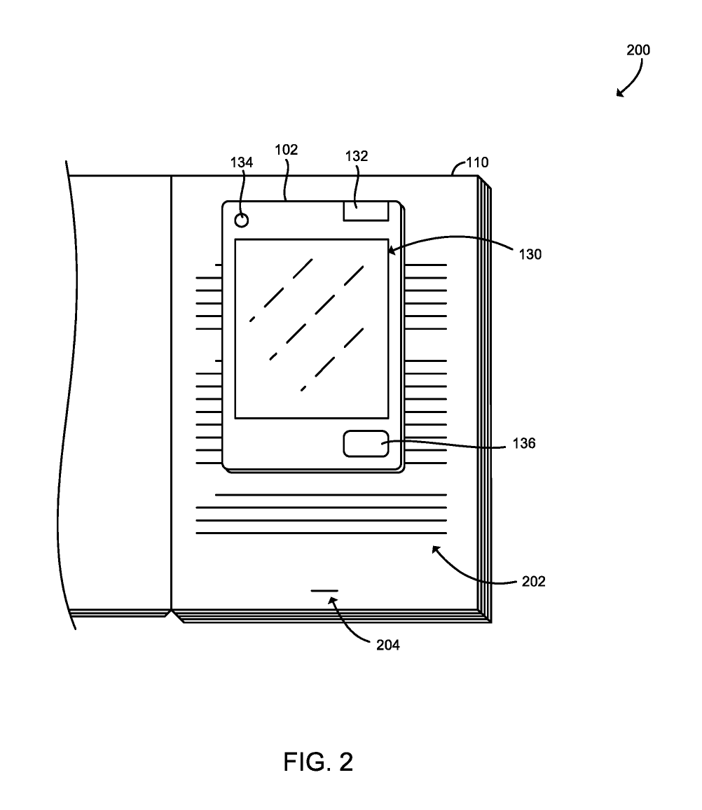

Referring now to FIG. 2, a schematic diagram 200 illustrates one potential embodiment of the smart bookmark device 102. As shown, the smart bookmark device 102 includes an e-ink display 130, an optical sensor 132, a microphone 134, and an input button 136. The smart bookmark device 102 may be placed on or near the physical book 110, which is open to a particular page corresponding to the user's current reading position. As shown, the page includes textual content 202 and a page number 204. In some embodiments, the smart bookmark device 102 may capture sensor data indicative of the user's current reading position by using the optical sensor 132 to capture image data of the textual content 202 and/or the page number 204. Additionally or alternatively, in some embodiments the smart bookmark device 102 may capture sensor data indicative of the user's current reading position by using the microphone 134 to capture the user speaking the current page number. The smart bookmark device 102 may capture the sensor data in response to a user input, such as the user pressing the input button 136. The smart bookmark device 102 may communicate with a nearby client computing device 106 (not shown in FIG. 2) using a low-power communication protocol such as Bluetooth® Low Energy.

As shown in the diagram 200, the smart bookmark device 102 may be embodied as a small, thin, low-power device capable of being placed in close proximity to the physical book 110. In some embodiments, the smart bookmark device 102 may be thin enough to serve as a physical bookmark; that is, the user may be able to close the physical book 110 with the smart bookmark device 102 between the pages. Of course, in some embodiments, rather than being a dedicated bookmark device, the smart bookmark device 102 may be embodied as a general-purpose device with an appropriate application, such as a smartphone.

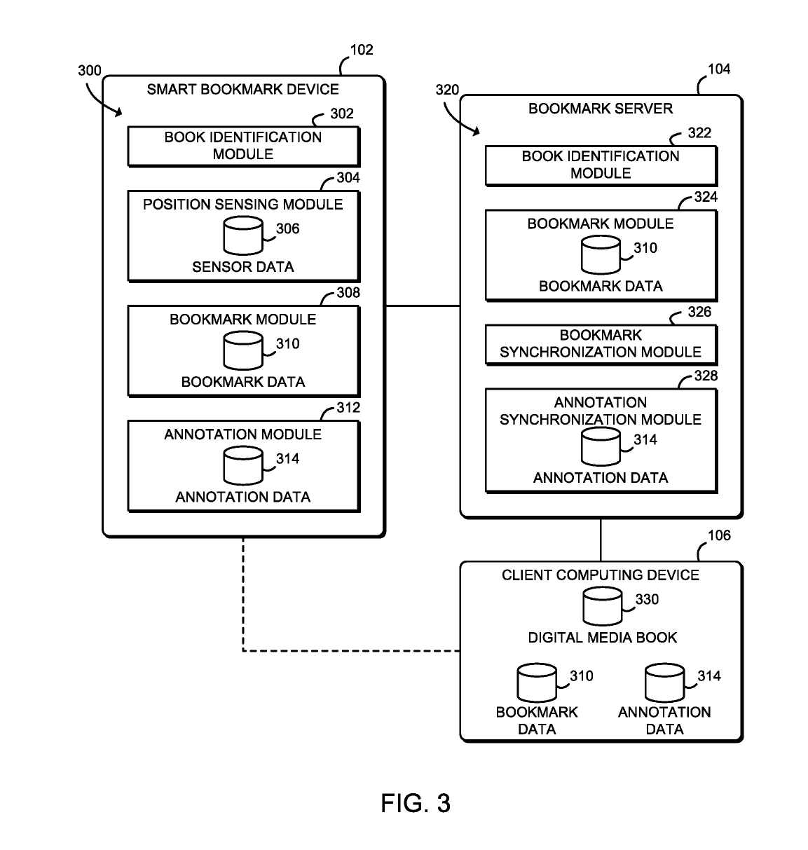

Referring now to FIG. 3, in an illustrative embodiment, the smart bookmark device 102 establishes an environment 300 during operation. The illustrative environment 300 includes a book identification module 302, a position sensing module 304, a bookmark module 308, and an annotation module 312. The various modules of the environment 300 may be embodied as hardware, firmware, software, or a combination thereof. As such, in some embodiments, one or more of the modules of the environment 300 may be embodied as circuitry or collection of electrical devices (e.g., book identification circuitry 302, position sensing circuitry 304, bookmark circuitry 308, and/or annotation circuitry 312). It should be appreciated that, in such embodiments, one or more of the book identification circuitry 302, the position sensing circuitry 304, the bookmark circuitry 308, and/or the annotation circuitry 312 may form a portion of one or more of the processor 120, the I/O subsystem 122, and/or other components of the smart bookmark device 102. Additionally, in some embodiments, one or more of the illustrative modules may form a portion of another module and/or one or more of the illustrative modules may be independent of one another.

The book identification module 302 is configured to transmit an identification of a physical book 110 to the bookmark server 104. The physical book 110 is currently being read by a user of the smart bookmark device 102. The identification of the book 110 may be embodied as, for example, a unique identifier of the book 110 or one or more images of pages of the book 110.

The position sensing module 304 is configured to capture sensor data 306 indicative of a current reading position of the user in the physical book 110, and to transmit the sensor data 306 to the bookmark server 104. Capturing the sensor data 306 may include, for example, capturing an image of a page of the book 110 with the optical sensor 132 or capturing audio data indicative of a user utterance with the audio sensor 134. In some embodiments, transmitting the sensor data 306 to the bookmark server 104 may include transmitting the sensor data 306 to the bookmark server 104 via a client computing device 106. In those embodiments, the smart bookmark device 102 and the client computing device 106 may be paired.

The bookmark module 308 is configured to receive bookmark data 310 from the bookmark server 104 in response to transmitting the sensor data 306. The bookmark data 310 may be embodied as any data indicative of the current reading position of the user in the physical book 110. The bookmark module 308 may be further configured to display a page number of the bookmark data 310 or to output an audio indication in response to receiving the bookmark data 310.

The annotation module 312 is configured to receive annotation data 314 from the bookmark server 104. The annotation data 314 is related to the physical book 110 and is generated by another computing device such as a client computing device 106. The annotation module 312 is further configured to indicate that the annotation data 314 is available in response to receipt of the annotation data 314. The annotation data 314 may be embodied as, for example, text data or audio data. In some embodiments, the annotation module 312 may be configured to generate annotation data 314 related to the physical book 110 and transmit the annotation data 314 to the bookmark server 104.

Still referring to FIG. 3, in the illustrative embodiment, the bookmark server 104 establishes an environment 320 during operation. The illustrative environment 320 includes a book identification module 322, a bookmark module 324, a bookmark synchronization module 326, and an annotation synchronization module 328. The various modules of the environment 320 may be embodied as hardware, firmware, software, or a combination thereof. As such, in some embodiments, one or more of the modules of the environment 320 may be embodied as circuitry or collection of electrical devices (e.g., book identification circuitry 322, bookmark circuitry 324, bookmark synchronization circuitry 326, and/or annotation synchronization circuitry 328). It should be appreciated that, in such embodiments, one or more of the book identification circuitry 322, the bookmark circuitry 324, the bookmark synchronization circuitry 326, and/or the annotation synchronization circuitry 328 may form a portion of one or more of the processor 140, the I/O subsystem 142, and/or other components of the bookmark server 104. Additionally, in some embodiments, one or more of the illustrative modules may form a portion of another module and/or one or more of the illustrative modules may be independent of one another.

The book identification module 322 is configured to receive an identification of a physical book 110 from the smart bookmark device 102. As described above, the physical book 110 is currently read by the user of the smart bookmark device 102. The book identification module 322 may be further configured to determine a format of the physical book 110 based on the identification of the book 110. In some embodiments, the identification of the book 110 may include a unique identifier of the book 110, and determining the format of the book 110 may include identifying the book 110 based on the unique identifier. In some embodiments, the identification of the book 110 may include an image of a page of the book 110, and determining the format of the book 110 may include recognizing content of the book 110 based on the image of the page of the book 110, and identifying the book 110 based on that content.

The bookmark module 324 is configured to receive sensor data 306 indicative of a current reading position of the user of the smart bookmark device 102 in the book 110. The bookmark module 324 is further configured to determine bookmark data 310 based on the sensor data 306. As described above, the bookmark data 310 is indicative of the current reading position of the user of the smart bookmark device 102 in the book 110. As described above, in some embodiments the sensor data 306 may include one or more images of pages of the book 110 that are generated by the optical sensor 132 of the smart bookmark device 102. Determining the bookmark data 310 may be embodied as recognizing textual content of the book 110 based on the images and identifying a page number in the textual content of the book 110, or by recognizing textual content of the book 110 and identifying a page number based on the textual content of the book 110 (e.g., by matching the textual content to a database of known books). Additionally or alternatively, as described above, in some embodiments the sensor data 306 may include audio data indicative of an utterance of the user of the smart bookmark device 102 generated by the audio sensor 134 of the smart bookmark device 102. Determining the bookmark data 310 may be embodied as recognizing textual content of the utterance of the user based on the audio data and identifying a page number in the textual content of the utterance.

The bookmark synchronization module 326 is configured to transmit the bookmark data 310 to the smart bookmark device 102. In some embodiments, the bookmark synchronization module 326 may be configured to transmit the bookmark data 310 to one or more additional computing devices, such as one or more client computing devices 106. A client computing device 106 may use the bookmark data 310 to adjust the playback position of a digital media book 330. The digital media book 330 may be embodied as any digital media representation of the physical book 110, such as an electronic book (e-book), audiobook, video media such as a movie based on a book or a video recording of a lecture corresponding to a transcript, or other digital media corresponding to the physical book 110. In particular, in some embodiments the digital media book 330 may have a different format from the physical book 110, be a different edition of the physical book 110, or otherwise include differences from the physical book 110. In some embodiments, the bookmark synchronization module 326 may be further configured to receive bookmark data 310 from a client computing device 106. The bookmark data 310 received from the client computing device 106 is indicative of a user's current playback position in a digital media book 330 that corresponds to the book 11. The bookmark synchronization module 326 may be further configured to generate the bookmark data 310 based on the bookmark data 310 received from the client computing device 106 and the identification and/or format of the physical book 110.

The annotation synchronization module 328 is configured to receive annotation data 314 from one or more computing devices such as a client computing device 106, and transmit the annotation data 314 to the smart bookmark device 102. As described above, the annotation data 314 is related to the physical book 110. The annotation data 314 may be embodied as, for example, text data or audio data. In some embodiments, the annotation synchronization module 328 may be configured to receive annotation data 314 from the smart bookmark device 102 and transmit the annotation data 314 to one or more other computing devices, such as client computing devices 106.

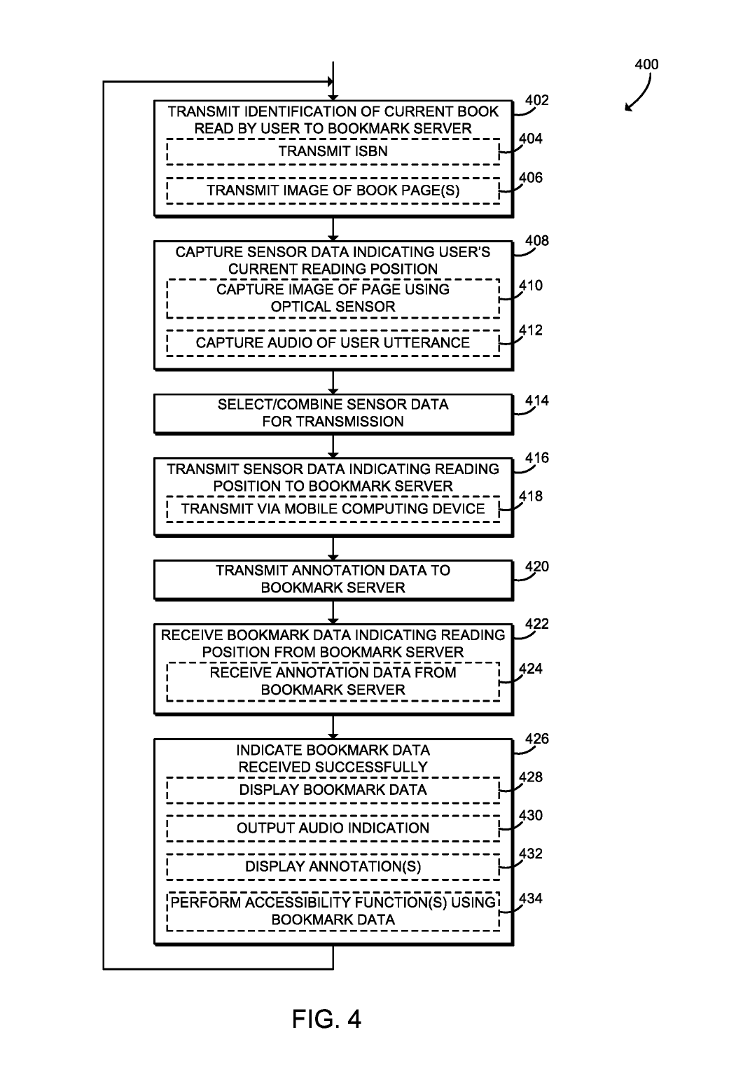

Referring now to FIG. 4, in use, the smart bookmark device 102 may execute a method 400 for bookmark data synchronization. It should be appreciated that, in some embodiments, the operations of the method 400 may be executed by one or more of the modules of the environment 300 of the smart bookmark device 102 as shown in FIG. 3. Additionally or alternatively, in some embodiments the method 400 may be embodied as various instructions stored on a computer-readable media, which may be executed by the processor 120 and/or other components of the smart bookmark device 102 to cause the smart bookmark device 102 to perform the method 400. The computer-readable media may be embodied as any type of media capable of being read by the smart bookmark device 102 including, but not limited to, the memory 124, the data storage device 126, other memory or data storage devices of the smart bookmark device 102, portable media readable by a peripheral device of the smart bookmark device 102, and/or other media. Additionally, although illustrated as being performed sequentially, it should be understood that in some embodiments the operations of the method 400 may be performed in a different order and/or at different times.

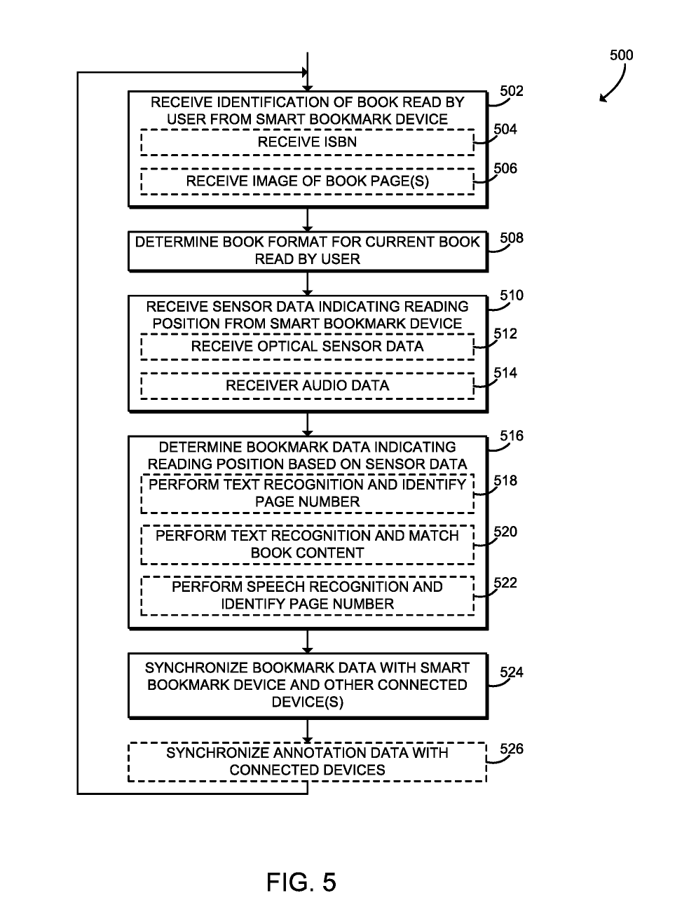

The method 400 begins with block 402, in which the smart bookmark device 102 transmits identification data of the physical book 110 currently being read by a user of the smart bookmark device 102 to the bookmark server 104. The identification data may be embodied as any captured sensor data, user input data, or other data that may be used to identify the current book 110. In some embodiments, in block 404 the smart bookmark device 102 may transmit an international standard book number (ISBN) or other unique identifier to the bookmark server 104. The ISBN is a commercial, standardized number that may be used to identify a particular edition of a book. The smart bookmark device 102 may determine the ISBN, for example, by scanning a barcode printed on the current book 110 or by receiving an ISBN that is input by the user. Although illustrated as transmitting an ISBN, it should be understood that in other embodiments the smart bookmark device 102 may transmit any data that uniquely identifies the current book 110, such as an alternative unique identification code or unique bibliographical data such as title, author, date, and/or other information. In some embodiments, in block 406 the smart bookmark device 102 may transmit images of one or more pages of the current book 110 to the bookmark server 104. As described further below in connection with FIG. 5, the bookmark server 104 may process the images to determine the textual content of the book 110, and the bookmark server 104 may identify the book 110 based on that content (e.g., by matching the content against a database of known books).

In block 408, the smart bookmark device 102 captures sensor data 306 indicating the user's current reading position. The user's current reading position may be embodied as any indication of the user's position in the current book 110, such as a page number that the current book 110 is currently opened to, the chapter, paragraph, or other textual subdivision that the user is currently reading, or other indication of reading position. The smart bookmark device 102 may capture the sensor data 306 in response to a user command such as activating a physical input button 136 or closing the physical book 110 around the smart bookmark device 102. Additionally or alternatively, in some embodiments the smart bookmark device 102 may actively monitor sensor inputs from the optical sensor 132, the audio sensor 134, and/or other sensors. The smart bookmark device 102 may capture sensor data 306 from any sensor(s) capable of determining the user's current reading position. In some embodiments, in block 410 the smart bookmark device 102 may capture one or more images of the current page or a part of the current page in the book 110 using the optical sensor 132. The captured images may be embodied as a digital image or other digital representation of the optical data captured by the optical sensor 132. For example, the user may take a picture of the current page (or a part of the current page such as the page number) using a camera 132 of the smart bookmark device 102. In some embodiments, in block 412, the smart bookmark device 102 may capture audio data using the audio sensor 134 that is indicative of an utterance by the user. For example, the user may speak the current page number, chapter number, or other indication of the reading position when ending a reading session.

Although illustrated as capturing the sensor data 306 using an optical sensor 132 and/or an audio sensor 134, it should be understood that in other embodiments the smart bookmark device 102 may capture the sensor data 306 using other types of sensors. For example, to capture text printed in braille, the smart bookmark device 102 may capture sensor data 306 using a depth camera or other sensor capable of detecting relief on the pages of the physical book 110.

In block 414, the smart bookmark device 102 selects and/or combines sensor data 306 for transmission to the bookmark server 104. The smart bookmark device 102 may, for example, combine multiple modes of sensor data 306 such as image data captured by the optical sensor 132 and audio data captured by the audio sensor 134.

In block 416, the smart bookmark device 102 transmits the sensor data 306 indicating the current reading position of the user to the bookmark server 104. As described further below in connection with FIG. 5, the bookmark server 104 processes the sensor data 306 to determine the current reading position of the user. In some embodiments, in block 418 the smart bookmark device 102 may transmit the sensor data 306 via a client computing device 106. For example, the smart bookmark device 102 may transmit the sensor data 306 to a paired mobile computing device (e.g., a client computing device 106 such as the user's smart phone) using a low-energy communication protocol such as Bluetooth® Low Energy. The paired mobile computing device may, in turn, transmit the sensor data 306 via the network 108 to the bookmark server 104.

In some embodiments, in block 420 the smart bookmark device 102 may transmit annotation data 314 to the bookmark server 104. The annotation data 314 includes one or more annotations, which may be embodied as text data, audio data, or any other data related to the current book 110 and generated by the smart bookmark device 102. For example, the user may create audio annotation data 314 while reading current book 110 by recording the audio annotation with the audio sensor 134. As another example, the user may create text annotation data 314 using one or more peripheral devices 136. As described further below, the bookmark server 104 may receive the annotation data 314 from the smart bookmark device 102 and transmit that annotation data 314 to one or more client computing devices 106. In some embodiments, the annotation data 314 may be related to the user's current reading position, or the annotation data 314 may identify a page number or other relevant position in the physical book 110.

In block 422, the smart bookmark device 102 receives bookmark data 310 from the bookmark server 104 that indicates the user's current reading position. The bookmark data 310 identifies the current reading position of the user, for example by indicating a page number that the current book 110 is currently opened to, the chapter, paragraph, or other textual subdivision that the user is currently reading, or other indication of reading position. The bookmark data 310 may be generated by the bookmark server 104 based on the sensor data 306 transmitted to the bookmark server 104 as described above in connection with block 416. Additionally or alternatively, the bookmark data 310 may correspond to bookmark data 310 generated by one or more client computing devices 106. The bookmark data 310 generated by a client computing device 106 may indicate the user's most recent position in a digital media book 330 corresponding to the physical book 110. For example, the bookmark data 310 may indicate the page of an e-book 330 that is currently being viewed using an e-reader device 106. As another example, the bookmark data 310 may indicate the timestamp of an audiobook 330 that is currently being played using a client computing device 106, or a similar position in any other type of media stream that corresponds to the physical book 110. As described further below, the user may synchronize the user's current reading position in the physical book 110 with the current reading position in the digital media book 330 by turning to an appropriate page in the physical book 110 as indicated by the bookmark data 310.

In some embodiments, in block 424 the smart bookmark device 102 may receive annotation data 314 from the bookmark server 104. The annotation data 314 includes one or more annotations, which may be embodied as text data, audio data, or any other data related to the current book 110 and generated by another device, such as a client computing device 106. For example, the user may create a textual annotation data 314 while reading an e-book 330 using a tablet computing device 106, and that annotation data 314 may be transmitted by the bookmark server 104 to the smart bookmark device 102. As another example, the user may create audio annotation data 314 while listening to an audiobook 330 using a client computing device 106, and that annotation data 314 may be transmitted by the bookmark server 104 to the smart bookmark device 102. In some embodiments, the annotation data 314 may be related to the user's current reading position, or the annotation data 314 may identify a page number or other relevant position in the physical book 110. Additionally or alternatively, in some embodiments, the annotation data 314 may be generated by a client computing device 106 used by a different user from the user of the smart bookmark device 102. For example, the smart bookmark device 102 may receive annotation data 314 related to the physical book 110 that was generated by friends, authors, or other social contacts of the user of the smart bookmark device 102.

In block 426, the smart bookmark device 102 indicates that the bookmark data 310 was received successfully. The smart bookmark device 102 may use any technique to indicate that the bookmark data 310 was received, and the particular technique used may depend on available output devices. In some embodiments, in block 428 the smart bookmark device 102 may display an indication using the display 130. For example, the smart bookmark device 102 may display the current page number from the bookmark data 310 using an e-ink display. When the bookmark data 310 corresponds to the user's reading position in another client computing device 106, the user may turn to the indicated page in the physical book 110 to synchronize reading positions. For example, the user may read ahead in an e-book using an e-reader 106, read the current page number from the display 130 of the smart bookmark device 102, and turn to the appropriate page in the physical book 110 to continue reading. In some embodiments, in block 430 the smart bookmark device 102 may output an audio indication. For example, the smart bookmark device 102 may output a predefined tone to indicate that the bookmark data 310 was received, or the smart bookmark device 102 may read aloud the page number from the bookmark data 310. Additionally or alternatively, in some embodiments in block 432 the smart bookmark device 102 may display one or more annotations associated with the current page of the bookmark data 310. For example, the smart bookmark device 102 may display textual content of an annotation that the user may access. In some embodiments, the smart bookmark device 102 may display an icon or other indication that the annotation is available, and may display the annotation in response to a user command.

In some embodiments, the smart bookmark device 102 may output audio for one or more annotations. In particular, in some embodiments the smart bookmark device 102 may generate speech output based on one or more text annotations. The speech generation may use the voice of a particular user, such as the user of the client computing device 106 that generated the annotation (even if that user is different from the user of the smart bookmark device 102). As another example, the speech output may use the voice of a narrator of an associated e-book.

In some embodiments, in block 434, the smart bookmark device 102 may perform one or more accessibility functions using the bookmark data 310. The smart bookmark device 102 may use the bookmark data 310, which indicates the user's current reading position, to perform functions to allow the user to more easily access the content of the physical book 110. For example, to improve access for visually impaired users, the smart bookmark device 102 may determine the current content of the physical book 110 using the bookmark data 310 and provide a large-print view of the content using the display 130. As another example, the smart bookmark device 102 may provide an audio output of the content using a text-to-speech generator or other audio version of the physical book 110. The smart bookmark device 102 may perform additional accessibility functions by, for example, allowing the user to map custom commands to one or more physical input buttons 136, which may improve ease of use for some users. After indicating that the bookmark data 310 was received successfully, the method 400 loops back to block 402, in which the smart bookmark device 102 may synchronize additional bookmark data 310.

Referring now to FIG. 5, in use, a bookmark server 104 may execute a method 500 for bookmark data synchronization. It should be appreciated that, in some embodiments, the operations of the method 500 may be executed by one or more of the modules of the environment 320 of the bookmark server 104 as shown in FIG. 3. Additionally or alternatively, in some embodiments the method 500 may be embodied as various instructions stored on a computer-readable media, which may be executed by the processor 140 and/or other components of the bookmark server 104 to cause the bookmark server 104 to perform the method 500. The computer-readable media may be embodied as any type of media capable of being read by the bookmark server 104 including, but not limited to, the memory 144, the data storage device 146, other memory or data storage devices of the bookmark server 104, portable media readable by a peripheral device of the bookmark server 104, and/or other media.

The method 500 begins with block 502, in which the bookmark server 104 receives from the smart bookmark device 102 identification data of the physical book 110 currently being read by a user of the smart bookmark device 102. As described above, the identification data may be embodied as any captured sensor data, user input data, or other data that may be used to identify the current book 110. In some embodiments, in block 504 the bookmark server 104 may receive an international standard book number (ISBN) or other unique identifier from the smart bookmark device 102. The ISBN is a commercial, standardized number that may be used to identify a particular edition of a book. The ISBN may be determined, for example, by scanning a barcode printed on the current book 110 or by receiving the ISBN via user input. Although illustrated as receiving an ISBN, it should be understood that in other embodiments the bookmark server 104 may receive any data that uniquely identifies the current book 110, such as an alternative unique identification code or unique bibliographical data such as title, author, date, and/or other information. In some embodiments, in block 506 the bookmark server 104 may receive images of one or more pages of the current book 110 from the smart bookmark device 102.

In block 508, the bookmark server 104 determines the book format for the current book 110 being read by the user of the smart bookmark device 102. The book format may include the information relating to the particular edition of the physical book 110, including the number of pages, the textual content of the book 110, the textual content for each page of the book 110, or other format information. The bookmark server 104 may use any technique to identify the format of the current book 110. For example, the bookmark server 104 may identify the format based on a unique identifier such as an ISBN received from the smart bookmark device 102. Additionally or alternatively, in some embodiments the bookmark server 104 may perform text recognition or otherwise process images received from the smart bookmark device 102 to determine the format of the book 110. The bookmark server 104 may identify the book 110 based on the content of the book 110, for example by matching the content against a database of known books.

In block 510, the bookmark server 104 receives sensor data 306 indicating the current reading position of the user from the smart bookmark device 102. As described above, the user's current reading position may be embodied as any indication of the user's position in the book 110, such as a page number that the current book 110 is currently opened to, the chapter, paragraph, or other textual subdivision that the user is currently reading, or other indication of reading position. The sensor data 306 may be captured from any sensor(s) of the smart bookmark device 102 capable of determining the user's current reading position. In some embodiments, in block 512 the bookmark server 104 may receive optical sensor data from the smart bookmark device 102. For example, the sensor data 306 may be embodied as one or more images of the current page in the book 110 captured using the optical sensor 132. In some embodiments, in block 514 the bookmark server 104 may receive audio data from the smart bookmark device 102. For example, the sensor data 306 may be embodied as audio data captured using the audio sensor 134 that is indicative of an utterance by the user.

In block 516, the bookmark server 104 processes the sensor data 306 and determines bookmark data 310 indicating the current reading position based on the sensor data 306. As described above, the bookmark data 310 identifies the current reading position of the user, for example indicating a page number that the current book 110 is currently opened to, the chapter, paragraph, or other textual subdivision that the user is currently reading, or other indication of reading position. The bookmark server 104 may perform any appropriate technique or combination of techniques to determine the bookmark data 310. In some embodiments, in block 518 the bookmark server 104 may perform text recognition on the sensor data 306 and identify a page number. For example, the bookmark server 104 may perform optical character recognition (OCR) on an image of the current page to determine the textual content of the page. The bookmark server 104 may identify the page number from within the textual content. In some embodiments, in block 520 the bookmark server 104 may perform text recognition on the sensor data 306 and match the book content. For example, the bookmark server 104 may perform OCR on an image of the current page to determine the textual content of the page. The bookmark server 104 may compare the recognized textual content or a snippet of the recognized textual content to the known textual content of the physical book 110, identified as described above in connection with block 508, to identify the page number of the current page. In some embodiments, in block 522 the bookmark server 104 may perform speech recognition on the sensor data 306 and identify a page number. For example, the bookmark server 104 may perform speech recognition or other natural language processing (NLP) on audio data to generate a textual representation of a user utterance. The bookmark server 104 may identify the page number spoken by the user using the textual representation.

In block 524, the bookmark server 104 synchronizes the bookmark data 310 with the smart bookmark device 102 and, in some embodiments, other connected device(s). The bookmark server 104 may transmit the bookmark data 310 to the smart bookmark device 102. As described above in connection with block 426 of FIG. 4, the smart bookmark device 102 may use the bookmark data 310 to display the current page number, perform accessibility functions, and otherwise enhance the reading experience of the physical book 110. The bookmark server 104 may also transmit the bookmark data 310 to one or more client computing devices 106. Each of the client computing devices 106 may use the bookmark data 310 to adjust playback position in a digital media book 330 that corresponds to the physical book 110. Thus, the user may be able to use the client computing device 106 to continue accessing the digital media book 330 from the same position as in the physical book 110. For example, an e-reader device 106 may change to the page in an e-book 330 corresponding to the current page of the physical book 110. As another example, a client computing device 106 may change to a timestamp in an audiobook 330 corresponding to the current page of the physical book 110. Additionally or alternatively, in some embodiments the bookmark server 104 may transmit bookmark data 310 received from one or more client computing devices 106 to the smart bookmark device 102. In those embodiments, the smart bookmark device 102 may indicate the position of the user in a digital media book 330, allowing the user to continue reading the physical book 110 from the same position. For example, the bookmark server 104 may receive bookmark data 310 indicating a timestamp in an audiobook 330 from a client computing device 106. The bookmark server 104 may convert the timestamp in the audiobook 330 into a page number in the physical book 110, for example using the book format of the physical book 110. The bookmark server 104 may then transmit the bookmark data 310 to the smart bookmark device 102 and/or other client computing devices 106. Additionally or alternatively, in some embodiments the bookmark server 104 may synchronize the bookmark data 310 with additional Internet-based content providers or ecosystems, allowing the user to synchronize bookmark data 310 across multiple service providers.

In block 526, in some embodiments the bookmark server 104 may synchronize annotation data 314 with one or more connected devices, including the smart bookmark device 102 and/or one or more client computing devices 106. As described above, the annotation data 314 includes one or more annotations, which may be embodied as text data, audio data, or any other data related to the current book 110 and generated by a device such as the smart bookmark device 102 and/or a client computing device 106. For example, the user may create a textual annotation data 314 while reading an e-book 330 using a tablet computing device 106, the user may create audio annotation data 314 while listening to an audiobook 330 using a client computing device 106, or the user may create audio annotation data 314 using the smart bookmark device 102 while reading the physical book 110. The bookmark server 104 may receive the annotation data 314 from a client computing device 106 and transmit that annotation data 314 to the smart bookmark device 102 (and/or other client computing devices 106). In some embodiments, the annotation data 314 may be related to the user's current reading position, or the annotation data 314 may identify a page number or other relevant position in the physical book 110. Additionally or alternatively, in some embodiments, the annotation data 314 may be generated by a client computing device 106 used by a different user from the user of the smart bookmark device 102. For example, the bookmark server 104 may transmit to the smart bookmark device 102 annotation data 314 related to the physical book 110 that was generated by friends, authors, or other social contacts of the user of the smart bookmark device 102. After synchronizing the bookmark data 310 and in some embodiments the annotation data 314, the method 500 loops back to block 502 to continue processing sensor data 306 from the smart bookmark device 102.

### EXAMPLES

Illustrative examples of the technologies disclosed herein are provided below. An embodiment of the technologies may include any one or more, and any combination of, the examples described below.

Example 1 includes a computing device for bookmark data synchronization, the computing device comprising: a book identification module to transmit an identification of a physical book to a bookmark server, wherein the physical book is currently read by a user of the computing device; a position sensing module to (i) capture sensor data indicative of a current reading position of the user in the physical book and (ii) transmit the sensor data to the bookmark server; and a bookmark module to receive, in response to transmission of the sensor data, bookmark data from the bookmark server, wherein the bookmark data is indicative of the current reading position of the user in the physical book.

Example 2 includes the subject matter of Example 1, and wherein the bookmark module is further to display a page number of the bookmark data in response to receipt of the bookmark data.

Example 3 includes the subject matter of any of Examples 1 and 2, and wherein the bookmark module is further to output an audio indication in response to receipt of the bookmark data.

Example 4 includes the subject matter of any of Examples 1-3, and wherein the identification of the physical book comprises a unique identifier of the physical book.

Example 5 includes the subject matter of any of Examples 1-4, and wherein the identification of the physical book comprises an image of a page of the physical book.

Example 6 includes the subject matter of any of Examples 1-5, and wherein to capture the sensor data comprises to capture an image of a page of the physical book with an optical sensor of the computing device.

Example 7 includes the subject matter of any of Examples 1-6, and wherein to capture the sensor data comprises to capture audio data indicative of a user utterance.

Example 8 includes the subject matter of any of Examples 1-7, and wherein to transmit the sensor data to the bookmark server comprises to transmit the sensor data to the bookmark server via a mobile computing device, wherein the computing device and the mobile computing device are paired.

Example 9 includes the subject matter of any of Examples 1-8, and further comprising an annotation module to: receive an annotation from the bookmark server, wherein the annotation is related to the physical book and wherein the annotation is generated by a second computing device; and indicate that the annotation is available in response to receipt of the annotation from the bookmark server.

Example 10 includes the subject matter of any of Examples 1-9, and wherein the annotation comprises text data or audio data.

Example 11 includes the subject matter of any of Examples 1-10, and further comprising an annotation module to: generate an annotation related to the physical book; and transmit the annotation to the bookmark server.

Example 12 includes a computing device for bookmark data synchronization, the computing device comprising: a book identification module to receive an identification of a physical book from a smart bookmark device, wherein the physical book is currently read by a user of the smart bookmark device; a bookmark module to (i) receive sensor data indicative of a current reading position of the user of the smart bookmark device in the physical book, and (ii) determine bookmark data based on the sensor data, wherein the bookmark data is indicative of the current reading position of the user of the smart bookmark device in the physical book; and a bookmark synchronization module to transmit the bookmark data to the smart bookmark device.

Example 13 includes the subject matter of Example 12, and wherein the book identification module is further to determine a format of the physical book read by the user of the smart bookmark device based on the identification of the physical book.

Example 14 includes the subject matter of any of Examples 12 and 13, and wherein: the identification of the physical book comprises a unique identifier of the physical book; and to determine the format of the physical book read by the user comprises to identify the physical book based on the unique identifier of the physical book.

Example 15 includes the subject matter of any of Examples 12-14, and wherein: the identification of the physical book comprises an image of a page of the physical book; and to determine the format of the physical book read by the user comprises to (i) recognize content of the physical book based on the image of the page of the physical book, and (ii) identify the physical book based on the content of the physical book.

Example 16 includes the subject matter of any of Examples 12-15, and wherein the sensor data comprises an image of a page of the physical book that is generated by an optical sensor of the smart bookmark device.

Example 17 includes the subject matter of any of Examples 12-16, and wherein to determine the bookmark data comprises to (i) recognize textual content of the physical book based on the image of the page of the physical book, and (ii) identify a page number in the textual content of the physical book.

Example 18 includes the subject matter of any of Examples 12-17, and wherein to determine the bookmark data comprises to (i) recognize textual content of the physical book based on the image of the page of the physical book, and (ii) identify a page number based on the textual content of the physical book.

Example 19 includes the subject matter of any of Examples 12-18, and wherein the sensor data comprises audio data indicative of an utterance of a user of the smart bookmark device, wherein the audio data is generated by an audio sensor of the smart bookmark device.

Example 20 includes the subject matter of any of Examples 12-19, and wherein to determine the bookmark data comprises to (i) recognize textual content of the utterance of the user based on the audio data, and (ii) identify a page number in the textual content of the utterance.

Example 21 includes the subject matter of any of Examples 12-20, and wherein the bookmark synchronization module is further to transmit the bookmark data to a second computing device.

Example 22 includes the subject matter of any of Examples 12-21, and wherein the bookmark synchronization module is further to: receive second bookmark data from a client computing device, wherein the second bookmark data is indicative of a user's current playback position in a digital media book that corresponds to the physical book; and generate the bookmark data based on the second bookmark data and the identification of the physical book.

Example 23 includes the subject matter of any of Examples 12-22, and wherein the digital media book comprises an e-book, an audiobook, or a video.

Example 24 includes the subject matter of any of Examples 12-23, and further comprising an annotation synchronization module to: receive an annotation from a second computing device, wherein the annotation is related to the physical book; and transmit the annotation to the smart bookmark device.

Example 25 includes the subject matter of any of Examples 12-24, and wherein the annotation comprises text data or audio data.

Example 26 includes the subject matter of any of Examples 12-25, and further comprising an annotation synchronization module to: receive an annotation from the smart bookmark device, wherein the annotation is related to the physical book; and transmit the annotation to a second computing device.

Example 27 includes a method for bookmark data synchronization, the method comprising: transmitting, by a computing device, an identification of a physical book to a bookmark server, wherein the physical book is currently read by a user of the computing device; capturing, by the computing device, sensor data indicative of a current reading position of the user in the physical book; transmitting, by the computing device, the sensor data to the bookmark server; and receiving, by the computing device in response to transmitting the sensor data, bookmark data from the bookmark server, wherein the bookmark data is indicative of the current reading position of the user in the physical book.

Example 28 includes the subject matter of Example 27, and further comprising displaying, by the computing device, a page number of the bookmark data in response to receiving the bookmark data.

Example 29 includes the subject matter of any of Examples 27 and 28, and further comprising outputting, by the computing device, an audio indication in response to receiving the bookmark data.

Example 30 includes the subject matter of any of Examples 27-29, and wherein transmitting the identification of the physical book comprises transmitting a unique identifier of the physical book.

Example 31 includes the subject matter of any of Examples 27-30, and wherein transmitting the identification of the physical book comprises transmitting an image of a page of the physical book.

Example 32 includes the subject matter of any of Examples 27-31, and wherein capturing the sensor data comprises capturing an image of a page of the physical book using an optical sensor of the computing device.

Example 33 includes the subject matter of any of Examples 27-32, and wherein capturing the sensor data comprises capturing audio data indicative of a user utterance.

Example 34 includes the subject matter of any of Examples 27-33, and wherein transmitting the sensor data to the bookmark server comprises transmitting the sensor data to the bookmark server via a mobile computing device, wherein the computing device and the mobile computing device are paired.

Example 35 includes the subject matter of any of Examples 27-34, and further comprising: receiving, by the computing device, an annotation from the bookmark server, wherein the annotation is related to the physical book and wherein the annotation is generated by a second computing device; and indicating, by the computing device, that the annotation is available in response to receiving the annotation from the bookmark server.

Example 36 includes the subject matter of any of Examples 27-35, and wherein the annotation comprises text data or audio data.

Example 37 includes the subject matter of any of Examples 27-36, and further comprising: generating, by the computing device, an annotation related to the physical book; and transmitting, by the computing device, the annotation to the bookmark server.

Example 38 includes a method for bookmark data synchronization, the method comprising: receiving, by a computing device, an identification of a physical book from a smart bookmark device, wherein the physical book is currently read by a user of the smart bookmark device; receiving, by the computing device, sensor data indicative of a current reading position of the user of the smart bookmark device in the physical book; determining, by the computing device, bookmark data based on the sensor data, wherein the bookmark data is indicative of the current reading position of the user of the smart bookmark device in the physical book; and transmitting, by the computing device, the bookmark data to the smart bookmark device.

Example 39 includes the subject matter of Example 38, and further comprising determining, by the computing device, a format of the physical book read by the user of the smart bookmark device based on the identification of the physical book.

Example 40 includes the subject matter of any of Examples 38 and 39, and wherein: receiving the identification of the physical book from the smart bookmark device comprises receiving a unique identifier of the physical book; and determining the format of the physical book read by the user comprises identifying the physical book based on the unique identifier of the physical book.

Example 41 includes the subject matter of any of Examples 38-40, and wherein: receiving the identification of the physical book from the smart bookmark device comprises receiving an image of a page of the physical book; and determining the format of the physical book read by the user comprises (i) recognizing content of the physical book based on the image of the page of the physical book, and (ii) identifying the physical book based on the content of the physical book.

Example 42 includes the subject matter of any of Examples 38-41, and wherein receiving the sensor data comprises receiving an image of a page of the physical book that is generated by an optical sensor of the smart bookmark device.

Example 43 includes the subject matter of any of Examples 38-42, and wherein determining the bookmark data comprises (i) recognizing textual content of the physical book based on the image of the page of the physical book, and (ii) identifying a page number in the textual content of the physical book.

Example 44 includes the subject matter of any of Examples 38-43, and wherein determining the bookmark data comprises (i) recognizing textual content of the physical book based on the image of the page of the physical book, and (ii) identifying a page number based on the textual content of the physical book.

Example 45 includes the subject matter of any of Examples 38-44, and wherein receiving the sensor data comprises receiving audio data indicative of an utterance of a user of the smart bookmark device, wherein the audio data is generated by an audio sensor of the smart bookmark device.

Example 46 includes the subject matter of any of Examples 38-45, and wherein determining the bookmark data comprises (i) recognizing textual content of the utterance of the user based on the audio data, and (ii) identifying a page number in the textual content of the utterance.

Example 47 includes the subject matter of any of Examples 38-46, and further comprising transmitting, by the computing device, the bookmark data to a second computing device.

Example 48 includes the subject matter of any of Examples 38-47, and further comprising: receiving, by the computing device, second bookmark data from a client computing device, wherein the second bookmark data is indicative of a user's current playback position in a digital media book that corresponds to the physical book; and generating, by the computing device, the bookmark data based on the second bookmark data and the identification of the physical book.

Example 49 includes the subject matter of any of Examples 38-48, and wherein the digital media book comprises an e-book, an audiobook, or a video.

Example 50 includes the subject matter of any of Examples 38-49, and further comprising: receiving, by the computing device, an annotation from a second computing device, wherein the annotation is related to the physical book; and transmitting, by the computing device, the annotation to the smart bookmark device.

Example 51 includes the subject matter of any of Examples 38-50, and wherein the annotation comprises text data or audio data.

Example 52 includes the subject matter of any of Examples 38-51, and further comprising: receiving, by the computing device, an annotation from the smart bookmark device, wherein the annotation is related to the physical book; and transmitting, by the computing device, the annotation to a second computing device.

Example 53 includes a computing device comprising: a processor; and a memory having stored therein a plurality of instructions that when executed by the processor cause the computing device to perform the method of any of Examples 27-52.

Example 54 includes one or more machine readable storage media comprising a plurality of instructions stored thereon that in response to being executed result in a computing device performing the method of any of Examples 27-52.

Example 55 includes a computing device comprising means for performing the method of any of Examples 27-52.

Example 56 includes a computing device for bookmark data synchronization, the computing device comprising: means for transmitting an identification of a physical book to a bookmark server, wherein the physical book is currently read by a user of the computing device; means for capturing sensor data indicative of a current reading position of the user in the physical book; means for transmitting the sensor data to the bookmark server; and means for receiving, in response to transmitting the sensor data, bookmark data from the bookmark server, wherein the bookmark data is indicative of the current reading position of the user in the physical book.

Example 57 includes the subject matter of Example 56, and further comprising means for displaying a page number of the bookmark data in response to receiving the bookmark data.

Example 58 includes the subject matter of any of Examples 56 and 57, and further comprising means for outputting an audio indication in response to receiving the bookmark data.

Example 59 includes the subject matter of any of Examples 56-58, and wherein the means for transmitting the identification of the physical book comprises means for transmitting a unique identifier of the physical book.

Example 60 includes the subject matter of any of Examples 56-59, and wherein the means for transmitting the identification of the physical book comprises means for transmitting an image of a page of the physical book.

Example 61 includes the subject matter of any of Examples 56-60, and wherein the means for capturing the sensor data comprises means for capturing an image of a page of the physical book using an optical sensor of the computing device.

Example 62 includes the subject matter of any of Examples 56-61, and wherein the means for capturing the sensor data comprises means for capturing audio data indicative of a user utterance.

Example 63 includes the subject matter of any of Examples 56-62, and wherein the means for transmitting the sensor data to the bookmark server comprises means for transmitting the sensor data to the bookmark server via a mobile computing device, wherein the computing device and the mobile computing device are paired.

Example 64 includes the subject matter of any of Examples 56-63, and further comprising: means for receiving an annotation from the bookmark server, wherein the annotation is related to the physical book and wherein the annotation is generated by a second computing device; and means for indicating that the annotation is available in response to receiving the annotation from the bookmark server.

Example 65 includes the subject matter of any of Examples 56-64, and wherein the annotation comprises text data or audio data.

Example 66 includes the subject matter of any of Examples 56-65, and further comprising: means for generating an annotation related to the physical book; and means for transmitting the annotation to the bookmark server.

Example 67 includes a computing device for bookmark data synchronization, the computing device comprising: means for receiving an identification of a physical book from a smart bookmark device, wherein the physical book is currently read by a user of the smart bookmark device; means for receiving sensor data indicative of a current reading position of the user of the smart bookmark device in the physical book; means for determining bookmark data based on the sensor data, wherein the bookmark data is indicative of the current reading position of the user of the smart bookmark device in the physical book; and means for transmitting the bookmark data to the smart bookmark device.

Example 68 includes the subject matter of Example 67, and further comprising means for determining a format of the physical book read by the user of the smart bookmark device based on the identification of the physical book.

Example 69 includes the subject matter of any of Examples 67 and 68, and wherein: the means for receiving the identification of the physical book from the smart bookmark device comprises means for receiving a unique identifier of the physical book; and the means for determining the format of the physical book read by the user comprises means for identifying the physical book based on the unique identifier of the physical book.

Example 70 includes the subject matter of any of Examples 67-69, and wherein: the means for receiving the identification of the physical book from the smart bookmark device comprises means for receiving an image of a page of the physical book; and the means for determining the format of the physical book read by the user comprises (i) means for recognizing content of the physical book based on the image of the page of the physical book, and (ii) means for identifying the physical book based on the content of the physical book.

Example 71 includes the subject matter of any of Examples 67-70, and wherein the means for receiving the sensor data comprises means for receiving an image of a page of the physical book that is generated by an optical sensor of the smart bookmark device.

Example 72 includes the subject matter of any of Examples 67-71, and wherein the means for determining the bookmark data comprises (i) means for recognizing textual content of the physical book based on the image of the page of the physical book, and (ii) means for identifying a page number in the textual content of the physical book.

Example 73 includes the subject matter of any of Examples 67-72, and wherein the means for determining the bookmark data comprises (i) means for recognizing textual content of the physical book based on the image of the page of the physical book, and (ii) means for identifying a page number based on the textual content of the physical book.

Example 74 includes the subject matter of any of Examples 67-73, and wherein the means for receiving the sensor data comprises means for receiving audio data indicative of an utterance of a user of the smart bookmark device, wherein the audio data is generated by an audio sensor of the smart bookmark device.

Example 75 includes the subject matter of any of Examples 67-74, and wherein the means for determining the bookmark data comprises (i) means for recognizing textual content of the utterance of the user based on the audio data, and (ii) means for identifying a page number in the textual content of the utterance.

Example 76 includes the subject matter of any of Examples 67-75, and further comprising means for transmitting the bookmark data to a second computing device.

Example 77 includes the subject matter of any of Examples 67-76, and further comprising: means for receiving second bookmark data from a client computing device, wherein the second bookmark data is indicative of a user's current playback position in a digital media book that corresponds to the physical book; and means for generating the bookmark data based on the second bookmark data and the identification of the physical book.

Example 78 includes the subject matter of any of Examples 67-77, and wherein the digital media book comprises an e-book, an audiobook, or a video.

Example 79 includes the subject matter of any of Examples 67-78, and further comprising: means for receiving an annotation from a second computing device, wherein the annotation is related to the physical book; and means for transmitting the annotation to the smart bookmark device.

Example 80 includes the subject matter of any of Examples 67-79, and wherein the annotation comprises text data or audio data.

Example 81 includes the subject matter of any of Examples 67-80, and further comprising: means for receiving an annotation from the smart bookmark device, wherein the annotation is related to the physical book; and means for transmitting the annotation to a second computing device.

1. A computing device for bookmark data synchronization, the computing device comprising:
a book identification module to transmit an identification of a physical book to a bookmark server, wherein the physical book is currently read by a user of the computing device;
a position sensing module to (i) capture sensor data indicative of a current reading position of the user in the physical book and (ii) transmit the sensor data to the bookmark server; and
a bookmark module to receive, in response to transmission of the sensor data, bookmark data from the bookmark server, wherein the bookmark data is indicative of the current reading position of the user in the physical book.

2. The computing device of claim 1, wherein the bookmark module is further to display a page number of the bookmark data in response to receipt of the bookmark data.

3. The computing device of claim 1, wherein to capture the sensor data comprises to capture an image of a page of the physical book with an optical sensor of the computing device.

4. The computing device of claim 1, wherein to capture the sensor data comprises to capture audio data indicative of a user utterance.

5. The computing device of claim 1, further comprising an annotation module to:
receive an annotation from the bookmark server, wherein the annotation is related to the physical book and wherein the annotation is generated by a second computing device; and
indicate that the annotation is available in response to receipt of the annotation from the bookmark server.

6. The computing device of claim 1, further comprising an annotation module to:
generate an annotation related to the physical book; and
transmit the annotation to the bookmark server.

7. One or more computer-readable storage media comprising a plurality of instructions that in response to being executed cause a computing device to:
transmit an identification of a physical book to a bookmark server, wherein the physical book is currently read by a user of the computing device;
capture sensor data indicative of a current reading position of the user in the physical book;
transmit the sensor data to the bookmark server; and
receive, in response to transmitting the sensor data, bookmark data from the bookmark server, wherein the bookmark data is indicative of the current reading position of the user in the physical book.

8. The one or more computer-readable storage media of claim 7, further comprising a plurality of instructions that in response to being executed cause the computing device to display a page number of the bookmark data in response to receiving the bookmark data.

9. The one or more computer-readable storage media of claim 7, wherein to capture the sensor data comprises to capture an image of a page of the physical book using an optical sensor of the computing device.

10. The one or more computer-readable storage media of claim 7, wherein to capture the sensor data comprises to capture audio data indicative of a user utterance.

11. A computing device for bookmark data synchronization, the computing device comprising:
a book identification module to receive an identification of a physical book from a smart bookmark device, wherein the physical book is currently read by a user of the smart bookmark device;
a bookmark module to (i) receive sensor data indicative of a current reading position of the user of the smart bookmark device in the physical book, and (ii) determine bookmark data based on the sensor data, wherein the bookmark data is indicative of the current reading position of the user of the smart bookmark device in the physical book; and
a bookmark synchronization module to transmit the bookmark data to the smart bookmark device.

12. The computing device of claim 11, wherein the book identification module is further to determine a format of the physical book read by the user of the smart bookmark device based on the identification of the physical book.

13. The computing device of claim 11, wherein the sensor data comprises an image of a page of the physical book that is generated by an optical sensor of the smart bookmark device.

14. The computing device of claim 13, wherein to determine the bookmark data comprises to (i) recognize textual content of the physical book based on the image of the page of the physical book, and (ii) identify a page number in the textual content of the physical book.

15. The computing device of claim 13, wherein to determine the bookmark data comprises to (i) recognize textual content of the physical book based on the image of the page of the physical book, and (ii) identify a page number based on the textual content of the physical book.

16. The computing device of claim 11, wherein the sensor data comprises audio data indicative of an utterance of a user of the smart bookmark device, wherein the audio data is generated by an audio sensor of the smart bookmark device.

17. The computing device of claim 11, wherein the bookmark synchronization module is further to transmit the bookmark data to a second computing device.

18. The computing device of claim 11, wherein the bookmark synchronization module is further to:
receive second bookmark data from a client computing device, wherein the second bookmark data is indicative of a user's current playback position in a digital media book that corresponds to the physical book; and
generate the bookmark data based on the second bookmark data and the identification of the physical book.

19. The computing device of claim 11, further comprising an annotation synchronization module to:
receive an annotation from a second computing device, wherein the annotation is related to the physical book; and
transmit the annotation to the smart bookmark device.

20. The computing device of claim 11, further comprising an annotation synchronization module to:
receive an annotation from the smart bookmark device, wherein the annotation is related to the physical book; and
transmit the annotation to a second computing device.

21. One or more computer-readable storage media comprising a plurality of instructions that in response to being executed cause a computing device to:
receive an identification of a physical book from a smart bookmark device, wherein the physical book is currently read by a user of the smart bookmark device;
receive sensor data indicative of a current reading position of the user of the smart bookmark device in the physical book;
determine bookmark data based on the sensor data, wherein the bookmark data is indicative of the current reading position of the user of the smart bookmark device in the physical book; and
transmit the bookmark data to the smart bookmark device.

22. The one or more computer-readable storage media of claim 21, further comprising a plurality of instructions that in response to being executed cause the computing device to determine a format of the physical book read by the user of the smart bookmark device based on the identification of the physical book.

23. The one or more computer-readable storage media of claim 21, wherein to receive the sensor data comprises to receive an image of a page of the physical book that is generated by an optical sensor of the smart bookmark device.

24. The one or more computer-readable storage media of claim 21, further comprising a plurality of instructions that in response to being executed cause the computing device to transmit the bookmark data to a second computing device.

25. The one or more computer-readable storage media of claim 21, further comprising a plurality of instructions that in response to being executed cause the computing device to:
receive second bookmark data from a client computing device, wherein the second bookmark data is indicative of a user's current playback position in a digital media book that corresponds to the physical book; and
generate the bookmark data based on the second bookmark data and the identification of the physical book.
